(19) United States
(12) Patent Application Publication
(10) Pub. No.: US 2005/0018230 A1
(43) Pub. Date: Jan. 27, 2005

(54) Multiple print modes that consume declining amounts of toner

(76) Inventors: Brett A. Green, Meridian, ID (US); John R. Hatten, Bois, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/627,178

(22) Filed: Jul. 25, 2003

(51) Int. Cl. G06F 15/00

(52) U.S. Cl. 358/1.13; 358/1.14

(57) ABSTRACT

In one embodiment, a method for controlling consumption of toner in a printing device having a supply of toner involves providing secondary print modes for printing on a print medium. Each of the secondary print modes is configured to consume the toner at different rates. At least certain of the secondary print modes consume the toner at lower rates than the given rate associated with a primary print mode of the printing device. Operation of the printing device is switched into selected ones of the secondary print modes so as to reduce a current rate of consumption of the toner as the supply of the toner is used.

### FIELD OF THE INVENTION

The invention relates to printing techniques and devices, and more particularly concerns progressively reducing the rate at which the toner used for printing is applied to the print medium.

### BACKGROUND OF THE INVENTION

Computer printers, copiers, facsimile machines and the like (all being examples of printers or printing devices) apply a contrast producing composition, such as liquid or dry powder ink or toner, to a medium to be printed, such as sheets of paper, plastic or other media. Contrast can be produced using a substance that is opaque, translucent, colored, etc. A printer can be used to coat a medium, but most often is used to mark or color selected local areas of the medium, so as to represent characters and/or images that can be seen and recognized. It is possible to form images on some media simply by application of energy (e.g., visibly altering a heat sensitive medium by so-called thermal printing), but the present subject matter concerns printers in which the contrast producing composition, or toner, is supplied from a reservoir containing a finite supply that is exhausted from time to time and needs to be replaced or refilled.

Different specific types of contrast producing compositions are used in different printers, and may be placed on the printed medium by electrostatic or other means. Specific contrast producing compositions might be fixed on the medium by drying, heat fusing and/or chemical curing, as appropriate. The contrast could result from the presence of the composition alone, or from an interaction between the composition and the medium, appearing under some form of illumination. For convenience, all such contrast and print-forming compositions and agents delivered to the printed media from a supply, whether such compositions are liquid or powder or aerosol or combinations thereof, etc., are termed “toner” in this document.

Some printers have the capability of notifying a user when a “low toner” condition within the printer is reached. This condition essentially notifies users that they are within some preset limit (e.g. 20%) of running completely out of toner. However, such devices, despite issuing the “low toner” notification, often continue to function in the same manner with respect to their continued use of the same amount of toner during printing operations, until the print fades completely on the page or simply drops out in certain areas of the page.

Other printers have some limited capability for saving toner when the toner is running low. For instance, some printers have a “toner save” mode, wherein a given proportion of dots (e.g., 75%) is removed from the dot image to be printed, in order to reduce toner consumption. The host computer can be used to instruct such printers to switch to the “toner save” mode, or the operating panel of the printer itself can be used to effect the switchover. However, this binary approach tends to result in immediate, significant deterioration in image quality as soon as the printer switches to the “toner save” mode, due to the removal of a significant number of dots. Alternative schemes for conserving toner upon reaching a “low toner” condition while minimizing perturbations in the aesthetic appearance and quality of the printed graphics and/or text information on the print medium are desired.

### SUMMARY

According to an aspect of the invention, a method for reducing the rate of toner consumption in a printing device comprises providing a plurality of secondary print modes for printing on a print medium. Each of the secondary print modes consumes toner at a different rate, preferably each such rate being less than the rate of consumption associated with the primary print mode of the printing device. The printing device advances from a current mode to a lower consumption mode in steps that are activated according to the level of toner remaining in the printer supply. These steps can be assumed at each of a plurality of successively lower sensed toner supply thresholds. Alternatively, the device can switch from one mode to a next lower consumption mode after a certain number of print sheets or jobs are completed in the previous mode, or both.

According to another aspect of the invention, a printing device having reduced toner consumption modes comprises a print processor responsive to an input signal for controlling or signaling for the production of print on a print medium. The printing device includes memory for storing information to define a hierarchy of secondary print modes. Each successive mode in the hierarchy is configured to consume less toner than the previous one. Each of the secondary print modes also is configured to consume less toner than that associated with a primary print mode of the printing device. A sensor detects when the level of toner in the printing device drops below a given threshold value and generates a control signal in response thereto, preferably consecutively sensing and signaling each of a plurality of thresholds as the supply is exhausted. The processor is responsive to the control signal for automatically switching from a current print mode to a next one of the secondary print modes in the hierarchy when passing thresholds. The processor and/or the associated printing device also can also be arranged to distinguish between modes based on the content to be printed, e.g., routinely or selectably employing a relatively higher quality mode for images and a relative lower quality mode for alphanumeric characters.

### BRIEF DESCRIPTION OF THE DRAWING

FIG. 1 is an illustration of an image forming system.

FIG. 2 is a cross-sectional view showing the internal contents of an exemplary printing device of the image forming system of FIG. 1.

FIG. 3 is a block diagram illustrating major components of a printing device according to an embodiment of the present invention.

FIG. 4 is an exemplary illustration of hierarchical print modes according to an aspect of the invention.

FIG. 5 is a flow chart depicting an exemplary methodology executable within the printing device according to an embodiment of the invention.

FIG. 6 is an exemplary illustration of operations of a printing device according to an aspect of the invention.

### DESCRIPTION OF EXEMPLARY EMBODIMENTS OF THE INVENTION

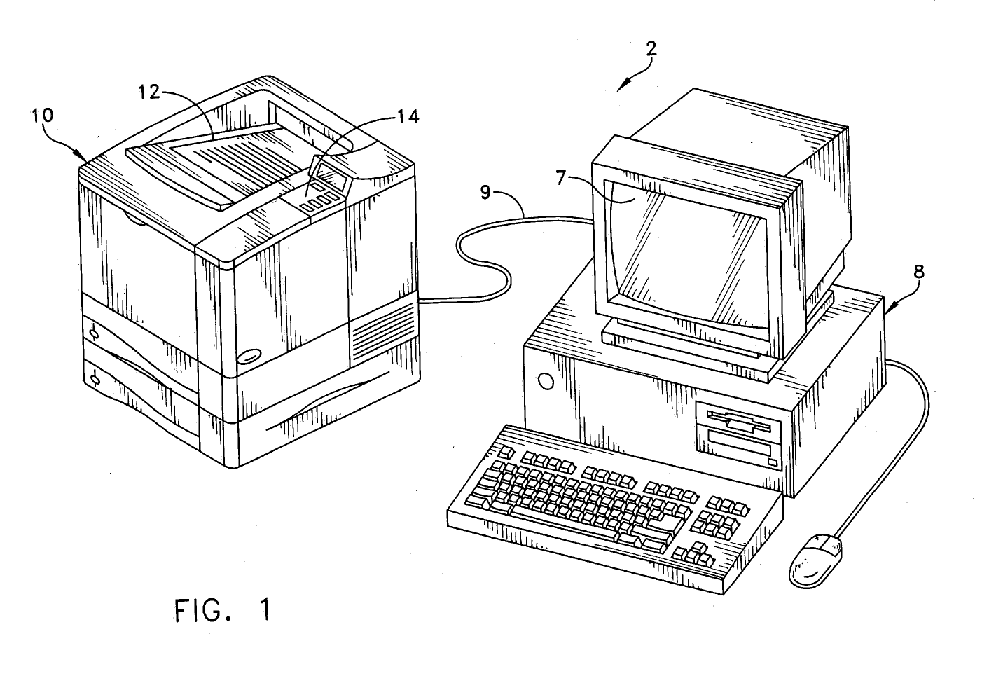

FIG. 1 shows an exemplary embodiment of an image forming system 2 comprising a host device 8 printing device 10, coupled to the host device 8 via communication medium 9. Host device 8 may be implemented as a personal computer (PC), server, Web server, or other device configured to communicate with printing device 10. In this embodiment, host device 8 includes a display 7 such as a CRT or flat panel monitor, and a keyboard and mouse, for exchange of information with a human user. An exemplary communication medium 9 could include a parallel connection direct to host device 8, or a packet switched network, such as a LAN or Intranet network (e.g., Ethernet arrangement), and/or WAN or Internet connection, or another communication configuration operable to provide electronic exchange of information between a host device 8 and printing device 10, using an appropriate protocol. Other image forming system arrangements are possible including one or more host devices 8 and/or additional printing devices 10, coupled at least at pertinent times over a data path represented generally by communication medium 9.

Printing device 10 is configured to fix images on media 12. The images are not limited as to content and might include one or more of characters, iconic symbols, lines, colors, shading, pictures, drawings or other forms of information and graphic depiction. The media 12 can comprise paper, envelopes, transparencies, labels or other material. The printing device 10 may be embodied as a laser printer, ink jet printer, dot matrix impact or thermal printer, dry medium printer, multiple function peripheral device, photocopier, facsimile machine, plotter, combination device or other arrangement configured to form images on media 12.

The printer is managed and operated by one or more digital processors responsive to stored programming. The processor and the stored program that the processor executes may be disposed in the printer or may be housed wholly or partly apart from the printer, e.g., in one or more circuit elements and/or programmed processors that are coupled to the printer over a data path (e.g., wired or wireless, direct or networked. As appropriate to the specific processor model and its configuration, the medium for practicing the invention can be in any code, whether higher or lower level, source or object, etc. The code can be embodied as self contained instructions or as one or more sets of constants and variables that are used or interpreted according to instructions contained elsewhere.

The processor typically contains arithmetic and logical elements coupled to registers and memory elements storing instructions and data. The processor can be contained in the printer, or can be located more or less in processors remote from the printer that are coupled to the printer over a data path (e.g., wired or wireless, direct or networked).

The steps that the processor and the printer undertake in coordination with one another are determined and managed according to the programming of the associated processor(s) and according to the data to be printed. The programming that controls operation likewise can be contained in the printer or distributed and made available to the processor that employs it. In this respect, the printer and its processors can be responsive to programming stored in a data carrier such as a semiconductor memory or on disk or CD or downloaded to a volatile memory from another source. The nature of such programming storage can be wholly or partly read-only or flash or worm. The programming instructions that actually are executed by the processor can be complete as supplied, or can be generated as the output of another process associated with the printer or the associated processor;

Thus, the subject invention resides in the program storage medium that constrains operation of the associated processors(s), and in the method steps that are undertaken by cooperative operation of the processor and the printing device, as well as in the printing system and printing device per se. These processes may exist in a variety of forms having elements that are more or less active or passive. For example, they exist as software program(s) comprised of program instructions in source code or object code, executable code or other formats. Any of the above may be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), flash memory, and magnetic or optical disks or tapes. Exemplary computer readable signals, whether modulated using a carrier or not, are signals that a computer system hosting or running the computer program may be configured to access, including signals downloaded through the Internet or other networks. Examples of the foregoing include distribution of the program(s) on a CD ROM or via Internet download. The same is true of computer networks in general.

In the form of processes and apparatus implemented by digital processors, the associated programming medium and computer program code is loaded into and executed by a processor, or may be referenced by a processor that is otherwise programmed, so as to constrain operations of the processor and the printers and/or other peripheral elements that cooperate with the processor. Due to such programming, the processor or computer becomes an apparatus that practices the method of the invention as well as an embodiment thereof. When implemented on a general-purpose processor, the computer program code segments configure the processor to create specific logic circuits. Such variations in the nature of the program carrying medium, and in the different configurations by which computational and control and switching elements can be coupled operationally, are all within the scope of the present invention

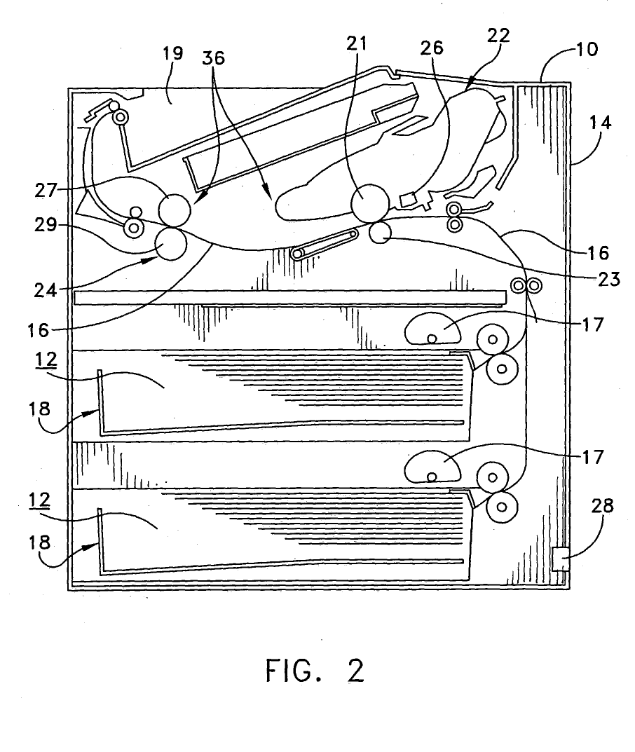

FIG. 2 shows certain internal arrangements in an exemplary printing device 10. Device 10 includes a housing 14 and rollers and guides defining a media path 16 along which media 12 is fed from supply trays 18, through various elements that place and fix toner at selected locations at least on one side of the media, and finally to an outlet bin 19.

For example, a number of rollers that are arranged in housing 14 direct media 12 along a media path 16 from one or more media supply trays 18 output bin 19. The media 12 is passed through a print engine 36 along media path 16. The print engine applies toner to the media 12 at locations and in amounts controlled by data received over communication medium 9. In this way the print engine forms characters, lines, symbols, shading, colors and the like (all generally termed “images”) on media 12. If necessary according to the type of toner used, the print engine also may operate to fix the applied toner, e.g., by allowing for drying or by application of heat or light energy that fuses the toner in place on media 12.

In the example shown, the print engine 36 includes a developing assembly 22 that applies toner at the required locations on the media 12 by selectively applying an incremental quantity of toner, or not applying such quantity, or by applying a relatively larger or smaller quantity of toner, at each potential spot in a printing field that occupies all or part of media 12. In the embodiment shown in FIG. 2, the toner is a powder type and a fusing assembly 24 is provided to fix the toner by heating. The invention is not limited to dry or powder toner printers that use heating to fix toner that is applied from a toner supply. The invention is also applicable to other sorts of toners that are metered out onto a media 12 from a supply. For example, the toner might comprise a volatile fluid mixture carrying an ink or particles of pigment. The toner could be a type that becomes fixed by drying, or by a chemical reaction, possibly including application of electromagnetic or light energy by the print engine 36, etc. The toner can comprise a combination of component materials.

Control circuitry (not shown in FIG. 2) is provided to control operation of device 10, including operation of the toner-application developing assembly 22 and the fusing assembly 24, if necessary. In one configuration, developing assembly 22 is implemented as a removable/replaceable toner cartridge, of the type provided with an onboard supply of toner, and replaced when the supply is exhausted. In the illustrated arrangement, developing assembly 22 of print engine 36 includes an imaging roller 21 and a transfer roller 23. Imaging roller 21 comprises a photoconductive or photosensitive drum surface. Such surfaces, for example, may be made to operate as insulators in the absence of incident light and to become electrically conductive when illuminated. The imaging roller is used to carry and apply toner selectively at each possible dot or pixel, using electrostatic forces. Imaging roller 21 may be implemented as a belt in an alternative configuration.

A sheet of media 12 being fed along media path 16 passes under or between imaging roller 21 and transfer roller 23. An image developed and carried by toner on the imaging roller 21 is transferred to the media sheet at a transfer nip between rollers 21, 23. A bias voltage is applied to transfer roller 23, which is placed on the opposite side of the passing media sheet, to induce an electric field through the media sheet, thereby moving the toner-carried images from the imaging roller 21 onto the media 12.

In the example of a powder toner transferred to sheet media 12 as described, it may be advantageous to fuse the toner with the media by application of heat or other energy, so that the applied images are not easily smeared or rubbed off after printing. Such fusing is not required in some other forms of toner such as volatile liquid toner, which may simply be allowed to dry. In the example, fusing assembly 24 is located further along media path 16 from the imaging and transfer rollers 21, 23. Fusing assembly 24 comprises a fusing roller 27 and a pressure roller 29, mounted at a fusing nip through which the media sheets pass. Fusing roller 27 preferably includes an internal heating element (not shown), operated at the nip to heat the media sheet and the applied toner thereon. The resulting heat flux from fusing roller 27 adheres the toner particles to the sheet media 12 and to one another. The images that were transferred to the media sheet 12 from the imaging roller 21 are thereby fixed.

According to an aspect of the invention, printing device 10 includes one or more sensors 26 configured to sense the amount of toner remaining in the supply, e.g., in the removable developing assembly 22. The sensor 26 detects when the amount of toner in the developing assembly 22 drops below a predetermined threshold amount, and generates a control signal in response thereto. The invention employs one or more control signals from one or more sensors 26 to cause triggering events that switch operation of the printing device 10 into a low toner operational mode in which the print parameters are adjusted to reduce the rate of toner consumption. Preferably, as the supply of toner is exhausted, the low toner operational mode passes through a series of successive stages in which less and less toner is used to print images that would normally require more toner but for the low toner operational mode.

Various types of sensor 26 can be used to detect a low toner condition. For example, the sensor can be responsive to a variable condition at the toner supply itself, such as the weight of the toner supply, the level of a liquid toner remaining in a reservoir or the like. Alternatively, the sensor can be responsive to an outside variable that correlates with the toner supply, such as the density of toner detected at a printed area on media 12 or at a test area such as a reserved area of the imaging roller 21. The density can be measured by pixel counting or dot counting, by opacity measurement or by another estimation method that produces a result similar to using a sensor 26 disposed substantially at the toner supply, to sense a low toner condition.

In a case in which the level of toner is detected, for example by two or more sensors 26 at different elevations in the toner supply, the control signals that correlate with the amount of toner remaining can be signals that are generated when the level of toner drops below each sensor in turn. Alternatively, control signals from one or more sensors can be combined with other data, such as the number of sheets printed since the toner level dropped below a sensor, to generate a set of secondary printing modes that is more numerous than the number of sensors provided. In a case where the sensed condition is the weight of the toner, one sensor may supply a signal having a range of values to which multiple thresholds can be applied.

In the embodiment shown, printing device 10 further includes an I/O interface 28 configured to couple with communication medium 9 for implementing communications externally of device 10, for example with host device 8 or other external devices that generates the data to be printed, or data from which the print data can be extracted, and/or the command to print. Interface 28 receives image data from communication medium 9 and device 10 subsequently forms images on media 12 using image data received via interface 28. In one embodiment, I/O interface 28 is a serial interface, such as a universal serial bus (USB) interface. In another embodiment, I/O interface 28 is a network interface. In other embodiments, other types of interfaces may be used, including those for wireless communications. The communications between the device 1 and the host device 8 are preferably bidirectional at least for reporting status information and preferably include a low toner indication.

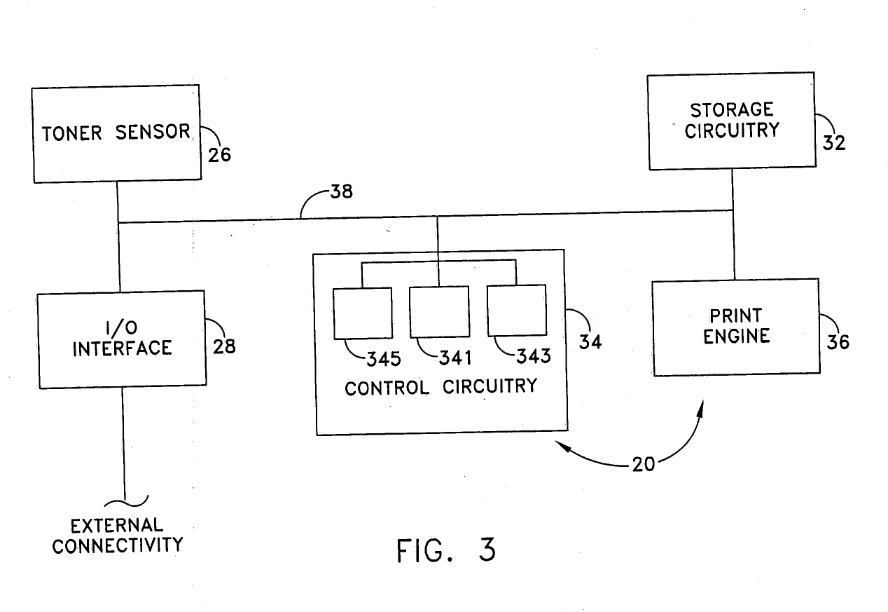

FIG. 3 shows a block diagram illustrating major components of printing device 10 configured to provide a hierarchy of secondary print modes having progressively reduced toner consumption rates. The printing device 10 is switched into the successive print modes to reduce the rate of toner consumption in at least general relation to the amount of toner remaining in the printing device. The depicted electrical circuitry of printing device 10 includes toner sensor 26, I/O interface 28, storage circuitry or memory 32, and imaging circuitry 20 (imaging circuitry 20 includes print control circuitry 34 and print engine 36) which are coupled for communication via bus 38.

Storage circuitry or memory 32 is configured to store electrical information such as image data for use in formulating images and instructions usable by print control circuitry 34 for implementing image forming operations within device 10. Exemplary storage circuitry 32 types include nonvolatile memory (e.g., EEPROM, flash memory and/or read-only memory (ROM)), random access memory (RAM) and hard disk and associated drive circuitry.

According to an aspect of the invention, a hierarchy of secondary print modes is established by data stored in memory 32. Each secondary mode in the hierarchy is configured to consume a different level of toner. Each different level consumed is less than that level of toner consumed when the printing device is configured in a primary print mode associated with normal printer and toner conditions. In one configuration, each secondary print mode in the hierarchy is associated with a corresponding toner threshold value indicative of a particular “low toner” level. More particularly, a plurality of toner threshold values are stored in memory 32 and are mapped to corresponding secondary print modes such that each decreasing threshold value is associated with a corresponding secondary print mode configured to exhibit decreased consumption of toner. In this manner, the hierarchy of secondary print modes ranging in order from a mode having the greatest consumption level to a mode having the least consumption level, are mapped to predetermined threshold levels of developing agent ranging from a highest threshold (e.g. 20% toner remaining) to a lowest threshold (e.g. 5% toner remaining).

The rate at which the toner is actually consumed will be determined by the content of images that are actually printed. For a given input image data file, the respective secondary modes consume successively less toner to print the same file, for example having successively less saturated (lighter) or thinner versions of lines, characters and symbols that are to correspond to the data. Inasmuch as the printing may involve a choice of the dots to print on a raster-like array of small dots or pixels, the successive modes that consume less toner can use fewer pixels, less dense pixel patterns, etc., to accomplish the reduction in toner consumption.

In response to print requests, control circuitry 34 operates to automatically select a corresponding next one of the secondary print modes in the hierarchy to configure the printer in a next-level reduced toner consumption mode (a lower rate of consumption relative to the previous print mode) each time it is determined that the residual toner level has dropped below another threshold in the hierarchy of decreasing threshold values.

As shown in FIG. 3, an exemplary configuration of control circuitry 34 is implemented as a processor 341, such as a dedicated microprocessor, configured to execute software and/or firmware executable instructions stored in memory such as ROM. Control circuitry 34 implements processing of graphics image data (such as rasterization) received via interface 28 in a graphics processor 343. Processing of text information (e.g., character text) received via interface 28 is accomplished in text processor 345 that may map character codes and font codes into an array of pixels to be darkened or not darkened or darkened to a predetermined size or extent of contrast.

Control circuitry 34 of imaging circuit 20 can perform functions with respect to the formation of images in addition to controlling application of pixel dots via print engine 36, such as controlling the feeding of the sheet media in coordination with image developer assembly 22 and fusing assembly 24, in the described embodiment. For example, control circuitry 34 obtains data via appropriate signals from toner sensor 26, determines whether a low threshold condition has occurred, and preferably-automatically activates a selected one of the secondary print modes to adjust (i.e. reduce) the level of toner consumption of print engine 36 during formation of images. Control circuitry 34 is also arranged to formulate messages for communication externally of printing device 10 to assist with the formation of images using device 10.

Although in one embodiment, advancing from one print mode to a next mode that consumes toner at a lower rate is an automatic function, it is possible to provide a capability for the user to override the progression and to use higher consumption rate print modes for selected print jobs. Alternatively, the user can have the capability wholly to switch off the toner conservation function and revert to the primary print mode indefinitely. As discussed above, this normally results in a sudden reduction in print quality when the toner supply is exhausted. According to the preferred advance from each mode to a next mode that consumes toner at a lower rate, the deterioration in print quality is gradual and the final exhaustion of the toner supply is deferred for a longer time.

In one configuration, storage circuitry 32 is configured to store a plurality of hierarchical secondary print modes corresponding to a plurality of respective toner threshold values. That is, circuitry 32 stores data that determines the details of operation in each of the modes. The modes can be implemented, for example, as a look-up table in storage circuitry 32. In that case, plural pixel mappings may be provided for each possible character, and selected among other alternatives in view of the rates at which the mappings differ in the amount of toner required (e.g., the proportion of possible pixels to be darkened).

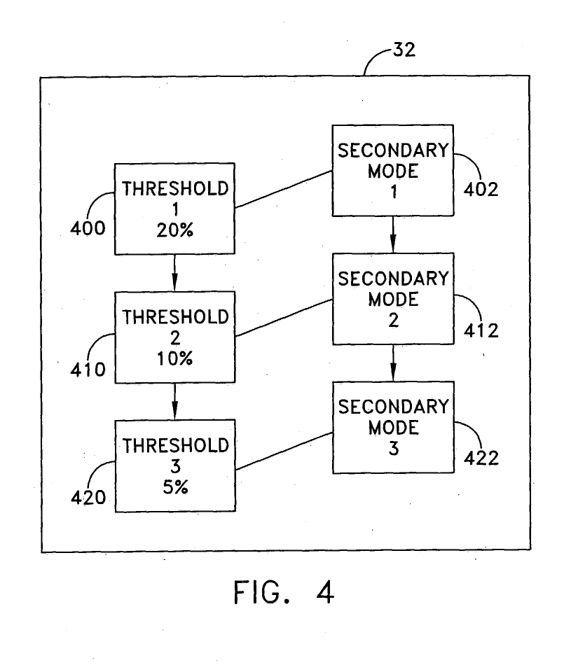

For example, one option is to include a set of toner sensors arranged at different elevations in the toner cartridge. As toner is consumed, the successively lower sensors become exposed to the air one at a time, indicating the relative amount of toner remaining. In that case the toner sensor elevations provide threshold values and the toner sensor outputs provide control signals that through processing including selection of secondary print modes, determine the rate of toner consumption. As illustrated in the exemplary configuration of FIG. 4, a first low toner threshold value 400 (for example at 20% of full capacity remaining) is mapped by storage circuitry 32 to secondary print mode 402. This mode may implement modified dither patterns, for example, which differ from those of the previous mode by using less toner for graphics data. The lower consumption mode is selected when the amount of toner drops below threshold 400.

A next lower toner threshold value 410 (indicative of for example 10% residual toner) is defined in memory 32 and mapped to secondary print mode 412. This next lower mode may be configured to implement both character thinning of text characters produced in response to print requests of text information, as well as modified dither patterns for graphics data. This next lower mode is selected when the amount of remaining toner drops below threshold 410. A third and still lower toner threshold value 420 (indicative of for example 5% residual toner) is stored in memory 32 and mapped to secondary print mode 422 configured to implement uniform pixel dropping across a page such that only every other pixel is printed when the amount of toner drops below threshold 420. In the foregoing sequence of successively lower rates of toner consumption, the toner conservation measures having less noticeable impact on print quality are taken first. More extreme methods of toner conservation are activated when the amount of toner remaining nears complete exhaustion.

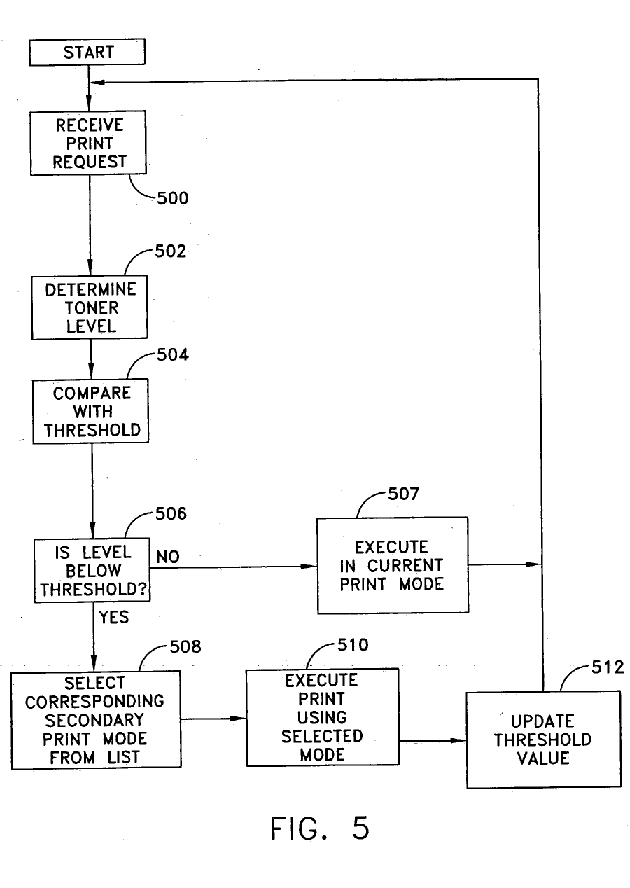

Referring to FIG. 5, an exemplary methodology executable within printing device 10 is shown. The depicted methodology is implemented as a series of ordered executable instructions stored within storage circuitry 32 and which are presented to control circuitry 34 for execution. In other alternative configurations, the depicted methodology is implemented in hardware, firmware and/or combinations thereof. The methodology of FIG. 5 depicts a plurality of aspects of the present invention. Individual ones of the depicted aspects and other aspects are implemented in one or more other respective executable methodology (not shown) in accordance with other arrangements of the present invention.

In accordance with the depicted methodology, print processor 341 of control circuitry 34 receives a print request (S500) and proceeds to determine the current toner level within the printer (S502). In an exemplary embodiment, the current toner level may be determined by a sensor within the printing device or may be determined by alternative methods, such as via pixel or dot counting. The current toner level is compared with a given toner threshold value (S504). If the current toner level exceeds the toner threshold value, the print request is executed via the appropriate graphics processor 343 (FIG. 3) or text processor 345 (depending on the type of print request) using the current print mode (S507). The nominal print mode used when the level of available toner exceeds the highest threshold is nominally the primary print mode during normal operations. Such normal operations could include selection of different levels of print quality at the user's option (e.g., a draft mode that prints faster and/or at lower print quality versus a final mode that prints slowly but at high quality). In that case, the invention can be arranged to affect both selectable modes or only one.

If the available toner level drops below the toner threshold value, processor 341 instructs the appropriate graphics processor 343 (FIG. 3) or text processor 345 to switch to a corresponding one of the secondary print modes stored in memory 32. This secondary print mode is characterized by a lower rate of toner consumption as compared to the previous mode (S508). The next print operation is executed in the newly selected print mode (S510). In the exemplary methodology, the present toner threshold value is updated with a decreased threshold value (S512) for use with the next print request. The print requests are serviced until the remaining toner level drops sufficiently to trigger advance to a next successive secondary print mode that is characterized by still further reduction in the toner consumption rate.

By switching to secondary print modes exhibiting progressively decreased consumption of toner in response to the decreasing level of the supply, preferably as a substantially automatic function of the printing device 10, a gradual diminution in image quality is achieved. The life of the toner supply is extended and used more efficiently because there is less tendency to refill or to substitute a supply that may be low but not yet critically so.

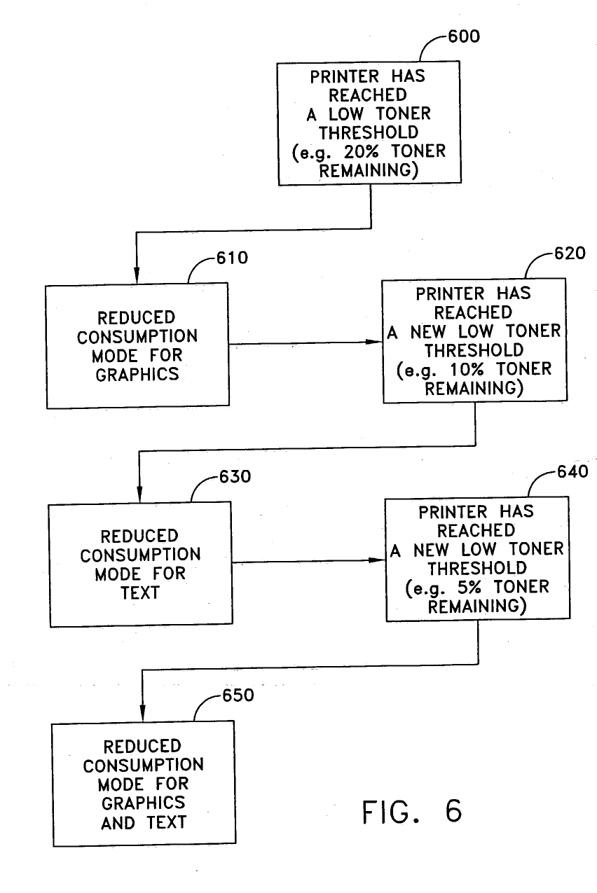

FIG. 6 is a simplified flow chart illustrating an exemplary operation of a printing device according to an aspect of the present invention. The printing device is configured to include a hierarchy of reduced toner consumption print modes. During print operations, when the printer toner level reaches a first low toner threshold condition (S600) (e.g. 20% toner remaining), the printer automatically switches to a reduced consumption print mode (S610) but only specifically for graphics print requests. The switch can involve changing to modified dither patterns that reduce the amount of toner used to represent certain graphics regions such as shaded. Various dither matrices having different pixel mappings may be automatically applied to reduce toner consumption according to a the algorithm used, typically providing an image of slightly reduced quality that is still aesthetically sufficient. The change might make the graphics slightly more grainy or could change light/dark brightness level or color saturation levels, but may not be easily noticed without comparing the printed product to a printing of the same data at a higher toner consumption level. In any event, printing continues until the printer reaches a new and lower toner threshold condition (S620) (e.g., 10% toner remaining). At that point, the printer switches to a reduced consumption print mode (S630) for text requests as well. For example, new and thinner character mapping can be substituted to produce text characters using less toner than before to produce the same text characters.

Character thinning can be applied to alphanumeric characters, lines and other features. Characters can be remapped using fewer pixels, for example, by eliminating pixels that would otherwise be printed (darkened) at the outer edges of the characters (the “outline”).

Alternatively, within the outlines of the characters pixels could be omitted or spaced more or overlapped less, etc., these options providing a range of different toner consumption rates for the same characters. Subsequent printing operations result in the printer reaching yet another low toner threshold condition (S640) (e.g. 5% toner remaining), causing the printer to automatically perform further toner reduction processing steps (S650). An example of a further step is uniform pixel dropping across a page. In an exemplary embodiment, printing of the graphics and/or text requests can be accomplished by blanking every nth pixel, such as every other pixel in the image, to provide maximum toner saving while still maintaining image quality under the circumstances.

The storage circuitry or memory 32 can contain a plurality of initial settings and hierarchical print modes of imaging parameters of which device 10 is capable. At subsequent times, it may be desired to configure or update the settings and modes corresponding to different types of print jobs and different user requirements within device 10. Host device 8 can be operable via software resident on the host to forward via interface 28 replacement or updated imaging parameter settings. These can include, for example, different toner threshold values, secondary print mode hierarchies and toner reduction algorithms, and threshold value/print mode mapping information, to enable a user to pre-configure operation of the printing device to automatically conserve toner based on user preferences. Alternatively, the above described configuration settings/modes may be chosen or updated from the controls on the front panel 14 (FIG. 1) of printing device 10, for example by selection from a menu.

Although the invention has been described and pictured in exemplary form with a certain degree of particularity, it is understood that the present disclosure of such form has been made only by way of example, and that numerous changes in the details of construction and combination and arrangement of parts may be made without departing from the spirit and scope of the invention as hereinafter claimed. It is intended that the patent shall cover by suitable expression in the appended claims, whatever features of patentable novelty exist in the invention disclosed.

1. A computer readable medium containing code for controlling operation of a processor associated with a printing device, the code being executable to perform a method comprising:
operating the printing device for printing on a print medium in a primary mode in which the printing device consumes toner at a given rate, from a supply of the toner;
operating the printing device in a selected one of a plurality of secondary print modes for printing on a print medium, the secondary print modes consuming the toner at different rates lower than the given rate associated with the primary print mode of the printing device; and
switching operation of the printing device into a selected one of said plurality of secondary print modes so as to reduce a current rate of consumption of the toner as the supply of the toner is used.

2. The computer readable medium of claim 1, wherein the code further controls operation of the processor for:
associating ones of said secondary print modes having successively lower rates of consumption with successively lower levels of the supply of the toner;
responding to at least one input that changes as the level of the toner drops below a corresponding one of said successively lower levels; and
wherein said switching into said selected one of said secondary print modes is responsive to a change in the input indicating that the level of the toner has dropped below a threshold related to the corresponding one of said successively lower levels.

3. The computer readable medium of claim 1, wherein the code further controls operation of the processor such that said switching operation selects a secondary print mode configured to consume toner at a rate lower than a rate of the current print mode for at least one of: a) graphics regions; b) text regions; and c) graphics regions and text regions.

4. The computer readable medium of claim 3, wherein the secondary print mode selected is configured to consume toner at a rate lower than the current print mode for graphics regions by modifying dither patterns to reduce consumption of toner used to print a same said graphics region in the selected secondary print mode versus the current print mode.

5. The computer readable medium of claim 3, wherein the secondary print mode selected is configured to consume toner at a rate lower than the current print mode for text regions by character thinning to reduce consumption of toner used to print a same said text region in the selected secondary print mode versus the current print mode.

6. The computer readable medium of claim 5, wherein character thinning comprises eliminating application of the toner at pixels corresponding to portions of text characters according to a given reduction algorithm.

7. The computer readable medium of claim 3, wherein a first selected one of said secondary print modes is configured to have progressively decreased consumption of toner comprises a mode which reduces consumption of toner for graphics only information and wherein a subsequent selected one of said secondary print modes comprises a mode which reduces consumption of toner for graphics information and text information.

8. The computer readable medium of claim 1, wherein the code controls operation of the processor to alter application of at least one of a particulate powder contrast forming composition and a liquid ink contrast forming composition forming said toner.

9. An encoded medium containing code for controlling operation of a digital processor associated with a printing device, the processor managing application of a toner comprising a contrast forming composition, from a supply of the toner that can be exhausted by continued printing, wherein the processor is constrained by the code to perform the steps of:
varying a rate of toner consumption in the printing device, among a primary print mode in which the toner is consumed at a given rate, and a hierarchy of secondary print modes, each mode consuming a different amount of toner in printing predetermined image data, each said different amount being less than an amount consumed in the primary print mode, said hierarchy of print modes ranging in order from a mode having a greatest rate of toner consumption to a mode having a least rate of toner consumption;
associating predetermined levels of toner with corresponding modes of said hierarchy of secondary print modes;
receiving print requests; and
switching from a current print mode to one of said secondary print modes in response to a determination that a current level of toner has dropped below one of said predetermined levels, whereby each successive print mode switched to in said hierarchy in response to said print requests exhibits progressively decreased consumption of toner.

10. A method for controlling consumption of toner in a printing device having a supply of the toner, the printing device having a primary print mode at which the toner is consumed at a given rate, the method comprising:
providing a plurality of secondary print modes for printing on a print medium, configured to consume the toner at different rates lower than the given rate associated with the primary print mode of the printing device; and
switching operation of the printing device into a selected one of said plurality of secondary print modes so as to reduce a current rate of consumption of the toner as the supply of the toner is used.

11. The method of claim 10, further comprising:
associating ones of said secondary print modes having successively lower rates of consumption with successively lower levels of the supply of the toner;
detecting when the level of the toner has dropped below a corresponding one of said successively lower levels; and
wherein said switching into said selected one of said secondary print modes is done in response to said detecting when the level of the toner has dropped below a threshold related to the corresponding one of said successively lower levels.

12. The method of claim 10, wherein said switching comprises selecting a secondary print mode configured to consume toner at a rate lower than a rate of the current print mode for at least one of: a) graphics regions; b) text regions; and c) graphics regions and text regions.

13. The method of claim 12, wherein the secondary print mode selected is configured to consume toner at a rate lower than the current print mode for graphics regions by modifying dither patterns to reduce consumption of toner used to print a same said graphics region in the selected secondary print mode versus the current print mode.

14. The method of claim 12, wherein the secondary print mode selected is configured to consume toner at a rate lower than the current print mode for text regions by character thinning to reduce consumption of toner used to print a same said text region in the selected secondary print mode versus the current print mode.

15. The method of claim 14, wherein character thinning comprises eliminating application of the toner at pixels corresponding to portions of text characters according to a given reduction algorithm.

16. The method of claim 12, wherein a first selected one of said secondary print modes is configured to have progressively decreased consumption of toner comprises a mode which reduces consumption of toner for graphics only information and wherein a subsequent selected one of said secondary print modes comprises a mode which reduces consumption of toner for graphics information and text information.

17. The method of claim 10, wherein said toner comprises at least one of a particulate powder contrast forming composition and a liquid ink contrast forming composition.

18. A printing device having reduced toner consumption modes comprising:
a print processor responsive to an input signal for printing information on a print medium by application of toner from a supply;
memory for storing a hierarchy comprising a primary print mode and a plurality of secondary print modes, each mode in said hierarchy configured to consume progressively less toner to print a given image, whereby each of said modes consumes the toner at a progressively lower rate than the primary print mode of the printing device;
at least one detector for detecting when a level of toner in the supply drops below a given one of a plurality of threshold values and for generating a control signal in response thereto;
wherein said processor is responsive to said control signal for switching from a current print mode to a next one of said secondary print modes in said hierarchy based on said detection.

19. The device of claim 18, wherein the print processor includes a graphics processor responsive to a print request for graphics data for switching dither patterns to print graphics information in a reduced toner consumption mode.

20. The device of claim 18, wherein the print processor includes a text processor responsive to a print request for text data for removing pixel data from characters to print text information in a reduced toner consumption mode.

21. The device of claim 18, wherein said plurality of threshold levels and said hierarchy of secondary modes are configurable by a user.

22. The device of claim 18, wherein said detector comprises a plurality of sensors disposed in said printer for sensing toner level, each sensor associated with a corresponding one of said plurality of threshold levels and operative to generate said control signal when the sensed current toner level crosses said respective threshold level.

23. The device of claim 22, wherein said plurality of level sensors are disposed within a cartridge in said printer and arranged such that, as the level of toner in the cartridge is consumed by ongoing printing, successive ones of the sensors are exposed to air, thereby generating said control signals.

24. A printer comprising:
means responsive to an input for applying toner from a supply in the printer to a print media so as to form images containing at least one of characters, symbols, lines, graphics and pictures on the print media;
means defining a correspondence between the input and the images, said correspondence affecting a rate at which the toner is applied to form the images during printing;
means for assessing a level of the toner in the supply, and providing a signal representing said level;
means responsive to the signal representing said level, operable to switch from a primary print mode employing one rate at which the toner is applied, to a secondary print mode employing a lower rate at which the toner is applied;
wherein the printer is successively switched in response to the signal representing the level, to successively lower rates of application of the toner, as the supply is exhausted.

25. The printer of claim 24, wherein the means defining the correspondence between the input and the images comprises a digital storage medium for one of storing and loading alternative versions of images corresponding to the input, each of the versions employing a different level of consumption of the toner and being selected by said means operable to switch from the primary print mode to the secondary print mode.

26. The printer of claim 24, wherein the means defining the correspondence between the input and the images comprises a processor operable to vary the images produced in response to the input, according to alternative processed versions, each of the versions employing a different level of consumption of the toner and being selected by said means operable to switch from the primary print mode to the secondary print mode.

27. The printer of claim 24, wherein the correspondence between the input and the images is selectively switched to reduce an amount of toner used for a subset of the group consisting of characters, symbols, lines, graphics and pictures, when switching from the primary print mode to the secondary print mode.

28. A method for operating a printing device in a manner that varies a rate of toner consumption in the printing device, said toner comprising a contrast forming composition provided from a supply in the printing device that can be exhausted by continued printing, the printing device having a primary print mode in which the toner is consumed at a given rate, the method comprising:
establishing a hierarchy of secondary print modes, each mode consuming a different amount of toner in printing predetermined image data, each said different amount being less than an amount consumed in the primary print mode, said hierarchy of print modes ranging in order from a mode having a greatest rate of toner consumption to a mode having a least rate of toner consumption;
associating predetermined levels of toner with corresponding modes of said hierarchy of secondary print modes;
receiving print requests; and
switching from a current print mode to one of said secondary print modes in response to a determination that a current level of toner has dropped below one of said predetermined levels, whereby each successive print mode switched to in said hierarchy in response to said print requests exhibits progressively decreased consumption of toner.

29. A computer readable medium encoded with computer program code such that, when the computer program code is executed by a processor of a computer, the processor performs a method comprising:
providing a plurality of secondary print modes for printing on a print medium, configured to consume toner at different rates, the different rates being lower than a given rate of toner consumption associated with a primary print mode for printing on a print medium; and
activating ones of said plurality of secondary print modes in response to a print request so as to reduce a current rate of consumption of toner as the supply of toner is used.
